(19) United States
(12) Patent Application Publication
(10) Pub. No.: US 2002/0143713 A1
(43) Pub. Date: Oct. 3, 2002

(54) Internet franking system

(76) Inventor: Peter Stutz, Hinterkappelen (CH)

Correspondence Address: PERMAN & GREEN, 425 POST ROAD, FAIRFIELD, CT, 06430, US

(21) Appl. No.: 10/081,576

(22) Filed: Feb. 22, 2002

Related U.S. Application Data
(60) Provisional application No. 60/270,796, filed on Feb. 23, 2001.
(60) Provisional application No. 60/277,806, filed on Mar. 22, 2001.
(60) Provisional application No. 60/277,841, filed on Mar. 22, 2001.
(60) Provisional application No. 60/277,873, filed on Mar. 22, 2001.
(60) Provisional application No. 60/277,931, filed on Mar. 22, 2001.
(60) Provisional application No. 60/277,946, filed on Mar. 22, 2001.
(60) Provisional application No. 60/338,892, filed on Nov. 5, 2001.

(51) Int. Cl. G06F 17/00

(52) U.S. Cl. 705/401; 705/410

(57) ABSTRACT

A modular franking system for processing envelopes into mailpieces having a path through the modules for performing processing steps on the envelopes such as weighing each envelope and calculating a franking charge for each mailpiece. The franking system includes a network protocol stack and a network controller or node that connects the system to a gateway such as a LAN. The LAN can allow access to the Internet. Via the LAN, the franking system can be remotely configured.

### CROSS-REFERENCE TO RELATED APPLICATIONS This application claims priority of the following U.S. provisional patent applications:

Serial No. 60/270,796 filed on Feb. 23, 2001;

Serial No. 60/277,806 filed on Mar. 22, 2001;

Serial No. 60/277,841 filed on Mar. 22, 2001;

Serial No. 60/277,873 filed on Mar. 22, 2001;

Serial No. 60/277,931 filed on Mar. 22, 2001;

Serial No. 60/277,946 filed on Mar. 22, 2001; and

Serial No. 60/338,892 filed on Nov. 5, 2001.

### BACKGROUND OF THE INVENTION

1. Field of the Invention

Value metering devices are devices that in their most basic form meter value. These devices take various forms such as, for example, postage meters (i.e. franking machines), various kinds of vending machines (i.e. lottery vending machines), tax stamp machines, various kinds of ticket dispensing machines, etc. Of these various devices, postage meters are one form of a value metering device that dispense value in the form of postage, e.g. postage indicia, basically either as a stand-alone type postage meter or as part of a mailing system. The stand-alone type postage meter is basically a postage meter having both its entire accounting system and security system positioned in a single secure housing, the accounting system being mechanically coupled to the printing mechanism which prints the postage related indicia. A major issue with standalone postage meters is the overall time and cost for any repair or maintenance that needs to be done to the stand alone unit. Any repair and/or maintenance generally needs to be done by a technician who is certified to perform such work by properly opening the securely sealed housing of the postage meter, performing the repair and/or maintenance work, and then re-securing the postage meter once the work is completed. The overall labor cost is therefore high, and the overall time that the meter is not functioning is a relatively long amount of time, i.e. a long amount of downtime.

In addition to the stand-alone type system as described above there are mailing systems that are formed of a mailing machine (i.e. a machine that can perform different mailing related functions (e.g. feeding, stacking, separating, sealing of envelopes, etc.)) on which a postage meter is securely mounted. The postage meter is typically located in a securely sealed housing, which contains the accounting and printing mechanisms. In the past few years both ink jet printing technology and smart card technology (i.e. smart cards used for securely housing the accounting circuitry of the postage meter) have been employed in these postage meters. The mailing machine systems including an electronic postage meter have enabled the users of such equipment to customize the exact type of mailing system they require by designing the overall mailing system in a modular fashion. One is able to set up a mailing system that will include individually removable mounted modules that can be added to or removed from the mailing system. For example, if one had a modular mailing system without an envelope stacker, one could add such a module to their system, and thereby have a mailing system that is able to stack envelopes once the postage has been placed on envelopes that are fed into the system. If the stacker module requires repair, the stacker could easily be removed for repair since it is but one module within a modular system. Features such as inserters, feeders/separators, sealers, scales, moisteners, addressers, stackers, etc. can be added for use with a postage meter to form different types of mailing systems.

It is desirable in accordance with the features of the present invention to have a mailing system that can be securely customized in a fast and reliable manner to control various kinds of external peripherals for handling mailpieces, such as for example, envelopes. It is also desirable to be able to securely customize a mailing system in accordance with customer needs, and to be able to connect various desired mail related peripherals to a mailing system without the need to provide a separate and dedicated electronic port to achieve such a system.

2. Brief Description of Related Developments

Existing systems have used modems coupled to a franking machine in two disadvantageous regards: (1) there are less and less phone lines available to connect a local franking machine to a remote computer, and (2) the modem is usually employed as a dedicated phone line. In addition, modems can present a security issues.

There are less and less analog phone lines available. Very often, there is no dedicated phone line available for the franking system. In contrast to a modem, a network gateway provides more security due to a usually installed firewall.

### SUMMARY OF THE INVENTION

The present invention is directed to a franking system. In one embodiment the system comprises a network controller and protocol stack software that allows the franking machine to communicate to any other system coupled to a LAN or any peer system coupled to the internet through a gateway to the internet.

In another aspect, the present invention is directed to a franking system including a network controller and protocol stack software for coupling the franking machine to a first LAN to a system connected to the internet by a second LAN.

In a further aspect, the present invention is directed to a franking system including modules coupled in series within a configuration authorized by the vendor and including a node controller and protocol stack software for coupling the franking machine to a LAN.

### BRIEF DESCRIPTION OF THE DRAWINGS

The foregoing aspects and other features of the present invention are explained in the following description, taken in connection with the accompanying drawings, wherein:

FIG. 1 is a perspective view of a modular franking machine incorporating features of the present invention.

FIG. 2 is a schematic diagram of two franking machines 20A and 20B coupled to one local area network or “LAN”, for example, an Ethernet LAN developed and promoted by the Xerox Corporation.

### DETAILED DESCRIPTION OF THE PREFERRED EMBODIMENTS

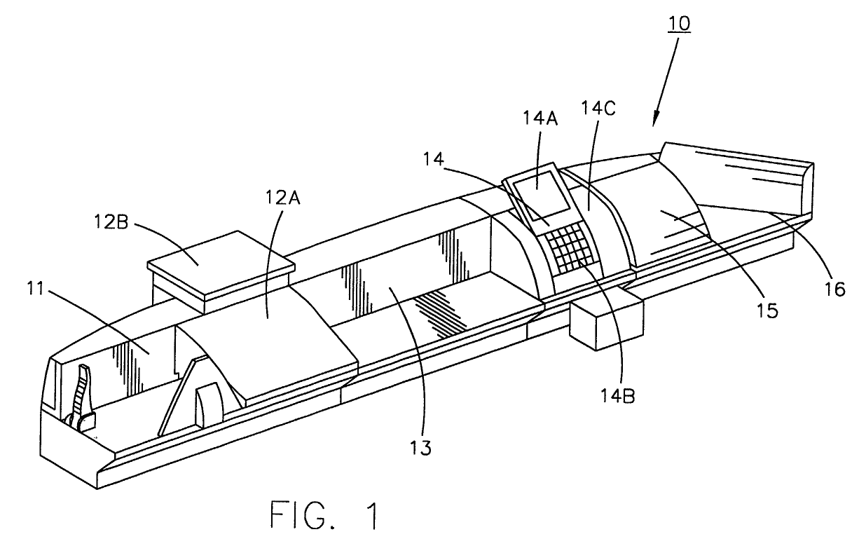

FIG. 1 is a block diagram of franking machine or system 10 illustrating five mailpieces processing modules. Generally, the modules are adapted to process mailpieces, such as for example, envelopes and cards. In alternate embodiments, any suitable articles or sheets can be processed other tan including mailpieces.

In one embodiment referring to FIG. 1, the modular franking machine 10 generally includes a module 11 that is a stacker feeder module for moving mailpieces such as envelopes into the downstream modules. Although the present invention is described herein as being used with mailpieces such as envelopes, it should be understood that the present invention can be used with any suitable article including sheets or cards. A second module can include a static weight scale 12 for weighing envelopes one at a time by hand before they are fed through the machine. The weight scale is used to calculate the franking charge. The system can also include a dynamic weight scale that weighs each mailpiece as it is transported through module 13.

Module 14 shown in FIG. 1 is generally referred to as the PowerPost™ module. The PowerPost™ module can house a host computer that is adapted to control the operations of the franking machine or system. The PowerPost module can include a display screen 14A and a data entry keyboard 14B. This module can also include an inkjet printer to print the postage onto an envelope. A sealing module 14c can be used to seal the envelope and the envelope can be moved to an output-stacking table 16.

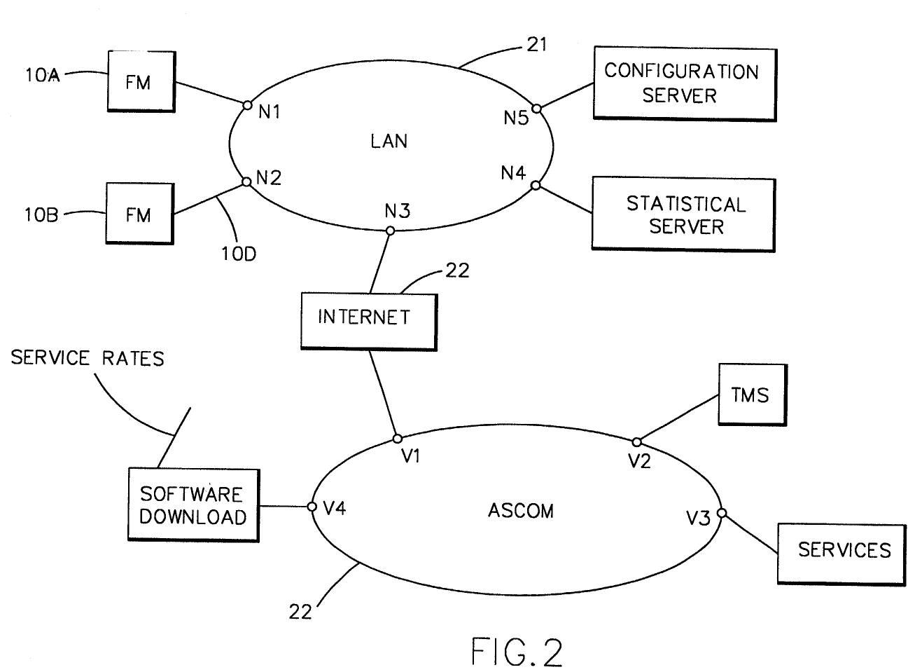

FIG. 2 is a schematic diagram of two franking machines 10A and 10B coupled to a local area network (“LAN”) 21, e.g. an Ethernet LAN. The host computer in the franking systems 10A and 10B can include a LAN protocol software stack and a network controller that couples the franking systems to LAN 21 at locations N1 and N2. The links to LAN 21 from the two franking machines 10A and 10B can create access for the franking machines 10A and 10B to the internet represented by the box 23.

Alternative connections to the internet can also include various kinds of wide area communication means including, for example, a dedicated leased line, an ISDN leased line, a SONET leased line and a satellite leased line. In addition, the franking systems or machines can have access to or include a web browser that utilizes a network controller and the network nodes N1 and N2 to access an intranet web server via LAN and the internet 23 (not shown) or a vendor's web server 22.

In one embodiment, funds required for the payment of postage can be downloaded to pre-qualified customers via the LAN 22 and the internet 23; or over a wide area network or from a TMS server. The funds are supplied by the web server coupled to node V4 of the vendor's LAN 22. LAN 22 can also include a server that can supply franking machine configurations to the vendor's customers by downloading one or more configurations directly to machines 10A and 10B or indirectly to the configuration server coupled to node N5 of LAN 21. The downloaded configurations enable the function of one or both franking machines to add or delete features involving the processing of envelopes. For example, system configurations from the franking machine can be supplied remotely via LAN downloads from a customer configuration server to customize a system 10A or 10B for specific franking jobs. This can include downloading the franking rates via LAN and internet to franking machines 10A and 10B. In addition, software can be downloaded to the franking system via LAN and the internet from a server of the printing machine vendor.

Postal statistics pertaining to machines 10A and 10B are stored on the server coupled to node N4 of LAN 21. The statistics are provided to the vendors web site 22 by an upload initiated either by a franking machine or by a request from the server at node V4 of LAN 22.

Remote diagnostic analysis can be conducted by uploading diagnostics data via the LAN and internet to a vendor's diagnostic server. Diagnostic analysis can also be performed via remote control of the franking system via the diagnostics server.

The present invention also allows for remote control of the franking system via LAN in order to control operation of the franking system by a remote system that could control other parts of the mailpiece processing process, that are not directly part of the franking system, for example, envelope inserters.

The system represented by systems of FIG. 2 provide more feature and advantages to franking machines 10A and 10B over prior art systems relying upon TMS services and WAN's. There is no need for dedicated phone lines. The security of the franking machines and the data they collect and the funds they house are more secure than prior art communication systems. The franking machines themselves are more secure because the LAN 21 includes a firewall coupled to the Internet.

The system of FIG. 2 avoids the need for high numbers of modems in the vendors infrastructure for supporting peak loads, provides higher transmission speeds and reduces the need for permanent connections such as required for modems.

Network functionality is achieved by having a network controller that physically attaches a franking machine to the network and protocol stack software that handles the lower layers of the required network communications protocols. On top of these protocols, there are several application protocols.

A franking machine or system incorporating features of the present invention generally includes a network controller and protocol stack software that allows the machine to communicate to any other system connected to a LAN or to any system connected to the internet if the LAN provides a gateway to the internet. The communication protocol to the to the peer system can be any protocol on top of the network protocol stack, including the protocol utilized in conjunction with a web browser in case the franking machine contains an optional web browser.

Independent of the existence of a web browser in the franking system, it contains one or several URLs identifying one or several servers that are contacted for various purposes.

In one embodiment, the franking machine or system contains a USB interface that can act as a USB master. Standard USB peripherals like modems and keyboards can be connected to the franking machine and be detected automatically. In case of a USB slave, the franking system acts like a peripheral to a PC and is regarded as a peripheral by the PC allowing for controlling the operation of the franking machine remotely.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A franking system comprising a network controller and protocol stack software that allows the franking system to be connected to a local area network and communicate to any other system coupled to the local area network.

2. The franking system of claim 1 wherein the network controller is adapted to allow a peer system to be coupled to an internet connector through a gateway to the internet.

3. The franking system of claim 1 wherein the network controller is adapted to use a communication protocol to a peer system that includes any protocol on top of the network controller protocol stack including the protocol utilized with a system web browser.

4. The franking system of claim 1 further including one or more universal resource locators (“URLs”) for identifying one or more servers that can be contacted by the system.

5. The franking system of claim 4 wherein the network controller further includes a web browser for accessing nodes on the internet with a URL.

6. A franking system comprising a network controller and protocol stack software for coupling the franking system to a first LAN to a system connected to the internet by a second LAN.

7. A franking system of claim 6 further including a universal serial bus (“USB”) master or slave for coupling the system to a display, modem, keyboard and other franking system peripherals including a LAN node.

8. The franking system of claim 1 wherein the network controller is adapted to couple the franking machine to a wireless network.

9. A franking system of claim 8 wherein the wireless network is a Bluetooth™ wireless network device.

10. A franking system of claim 1 wherein the network controller is further adapted to couple the franking system to a wide area network (“WAN”).

11. The franking system of claim 10 wherein the WAN is an ISDN network.

12. The franking system of claim 10 wherein the WAN is a SONET network.

13. The franking system of claim 10 wherein the WAN is a Satellite network.

14. The franking system of claim 10 wherein the WAN is an ISDN network.

15. The franking system of claim 1 wherein a WEB browser uses the protocol stack and the network node to access an intranet web server via the internet.

16. A franking system comprising a franking system including modules coupled in series within a configuration authorized by the vendor and including a node controller and protocol stack software for coupling the franking machine to a LAN.

17. The franking system of claim 16 further including a configuration server coupled to the LAN and including a data storage device including data identifying a vendor authorized configuration for the franking modules.

18. The franking system of claim 16 further including a statistical server coupled to the LAN and including a data storage device including franking rates of post office and commercial couriers.

19. The franking system according to claim 1 wherein the system is adapted to download funds via the local area network and an Internet connector from a secure funds server.

20. The franking system according to claim 1 wherein the system is adapted to be remotely controlled via the local area network by a remote system.
